(19) United States
(12) Patent Application Publication
(10) Pub. No.: US 2004/0036689 A1
(43) Pub. Date: Feb. 26, 2004

(54) Method for capturing and creating an animated image

(76) Inventor: Hung-Chun Chiu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/644,805

(22) Filed: Aug. 21, 2003

(30) Foreign Application Priority Data
Aug. 23, 2002 (TW) 91119094

(51) Int. Cl. G06T 15/70

(52) U.S. Cl. 345/473

(57) ABSTRACT

An image animation method which positions facial features to a predefined facial mask providing an efficient and easy system for animating the selected features, is disclosed. A mask shows proper positioning of the subject. For example, if the face of a subject is to be animated, the eyes and mouth region are displayed in the mask. The position is adjusted until the facial features of the subject fit the associated regions of the mask. The areas of the image overlayed by the mask are selected using the coordinates of the mask areas. The areas of the image overlayed by the mask are transformed and result in an animated image. Only the image along with the location coordinates of the mask need to be stored. This results in a very small file size, making transfer and storage simple.

### BACKGROUND OF THE INVENTION

1. Field of Invention

The present invention relates to animation, and more particularly, to an image animation method which positions facial features to a predefined facial mask providing an efficient and easy system for animating the selected features.

2. Description of the Related Art

Due to the fast development of multi-media, animation has an important leading role in multi-media. For animation, an animal or human or an action of any kind of object is manipulated to show movement. For utilization in mobile phones, how to produce an animated image of a lifelike action is a current challenge. Constructing the animation is one difficulty but also, the file size of the animation must be very small in order to be effectively used in mobile phone systems.

Some animations are created by creating an image for each frame of the animation. In this method, the file size is large as a new image must be loaded for each frame of the animation. This is not effective or useful when applied to mobile phone technology. Therefore, a more efficient animation method is needed that can simply create an animation that is small in file size and can be produce easily.

### SUMMARY OF THE INVENTION

To achieve these and other advantages and in order to overcome the disadvantages of the conventional method in accordance with the purpose of the invention as embodied and broadly described herein, the present invention provides an image animation method which positions facial features to a predefined facial mask providing an efficient and easy system for animating the selected features.

It is an object of the present invention to provide a method for animating an image which positions facial features to a predefined facial mask providing an efficient and easy system for animating the selected features.

It is another object of the present invention to provide a method for animating an image which only needs the said image and characteristics in order to mark the site coordinates to be handled by the animation program, and can immediately obtain an image animation effect with a reduced file size.

The present invention provides a method for animating an image comprising: setting at least one characteristic mark of a target image which marks the area of the image to be animated; taking the characteristic of the image to overlay the target image; and saving the target image and the coordinal value of the characteristic mark, transforming the characteristic of the target image in accordance with the coordinal value of the characteristic mark and the target image. In this way, a portable electronic device, for example a mobile phone, only needs to receive the target image and the coordinal value of characteristic mark of the target image and transforms the characteristic mark of the target image with animation software.

In application, a device for animating an image comprises: a lens for capturing the target image; a characteristic transparent film having at least one characteristic mark to overlay the target image; a viewfinder for checking the characteristic mark overlays the image; and a storage for storing the target image and at least one coordinal value of said characteristic mark to be used with animation software.

These and other objectives of the present invention will become obvious to those of ordinary skill in the art after reading the following detailed description of preferred embodiments.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a flowchart illustrating a method for animating an image according to an embodiment of the present invention;

FIG. 2 is a diagram illustrating a method for animating an image according to an embodiment of the present invention;

FIG. 3 is a diagram illustrating additional functions of a method for animating an image according to an embodiment of the present invention; and

FIG. 4 is a diagram illustrating a method for animating an image according to an embodiment of the present invention.

### DETAILED DESCRIPTION OF PREFERRED EMBODIMENTS

Reference will now be made in detail to the preferred embodiments of the present invention, examples of which are illustrated in the accompanying drawings. Wherever possible, the same reference numbers are used in the drawings and the description to refer to the same or like parts.

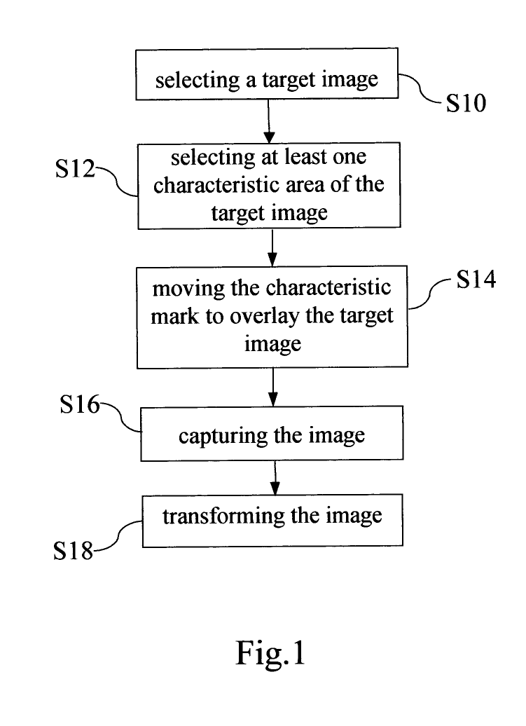

Refer to FIG. 1, which is a flowchart illustrating a method for animating an image according to an embodiment of the present invention.

First, in step 10, a target image is selected. In step 12, at least one characteristic mark of the target image is selected for transforming. Next, in step 14, the at one characteristic mark is moved to overlay the target image. In step 16, the target image and the at least one coordinal value of the characteristic mark overlaying the target image, is captured. Finally, in step 18, the characteristic selecting area of the target image is transformed by at least one coordinal value of the characteristic mark.

There are two methods for accomplishing step 14. One method uses a default template where the location of the characteristic mark is fixed. The size or location can not be adjusted by the user. The default template uses a mask wherein the location of the at least one characteristic mark is pre-determined. For this method, the user uses the pre-determined mask to align and orient the target image before capture. Therefore, the at least one characteristic mark is not moved to overlay the target image in this method.

In the other method, the mask is adjustable. The size, location, aspect ratio, etc. can be adjusted. This allows for flexible application in positioning the at least one characteristic marks to the target image.

The characteristic mark of the target image selects from one of the characteristic mark databases that includes many kinds or types, for example: faces of human, animals or others still images. The user can choose a characteristic mark from the database to match with the target image. The database is made of average values of characteristic marks of similar target images. Step 14 further comprises a fine tuning step of adjusting the characteristic mark for getting the characteristic mark to exactly overlay the target image. The characteristic selecting area of the target and coordinal value of the position can be transferred to any portable electronic device, for example: mobile phone, notebook or personal digital assistant, which can animate the image with voice or audio.

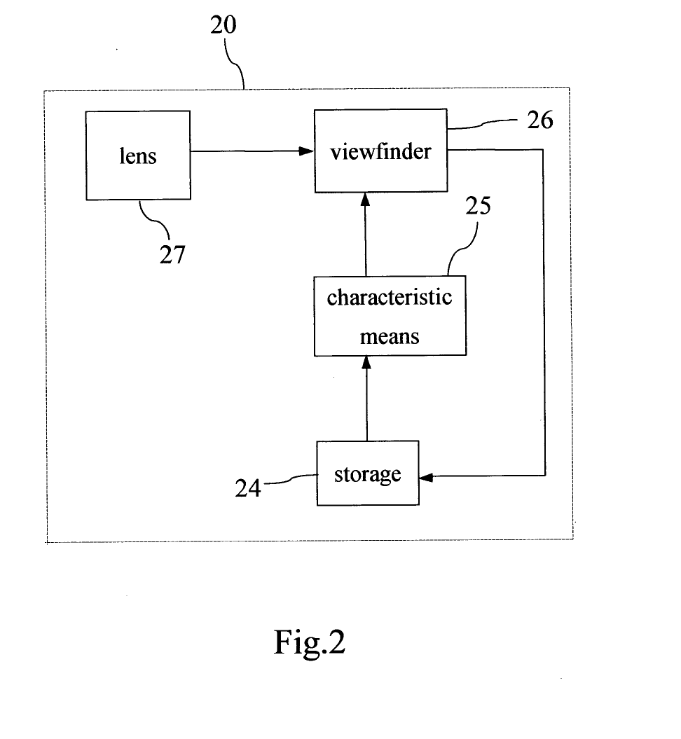

Refer to FIG. 2, which is a diagram illustrating a method for animating an image according to an embodiment of the present invention.

In application of the present invention, an apparatus 20 for animating an image comprising a lens 27 for capturing the target image; a characteristic means 25 for setting at least one characteristic mark of the target image in order to transform a characteristic selecting area of the target image; a viewfinder 26 for checking the characteristic mark overlays the image; and a storage 24 for storing the target image and at least one coordinal value of the characteristic mark and being animated by software.

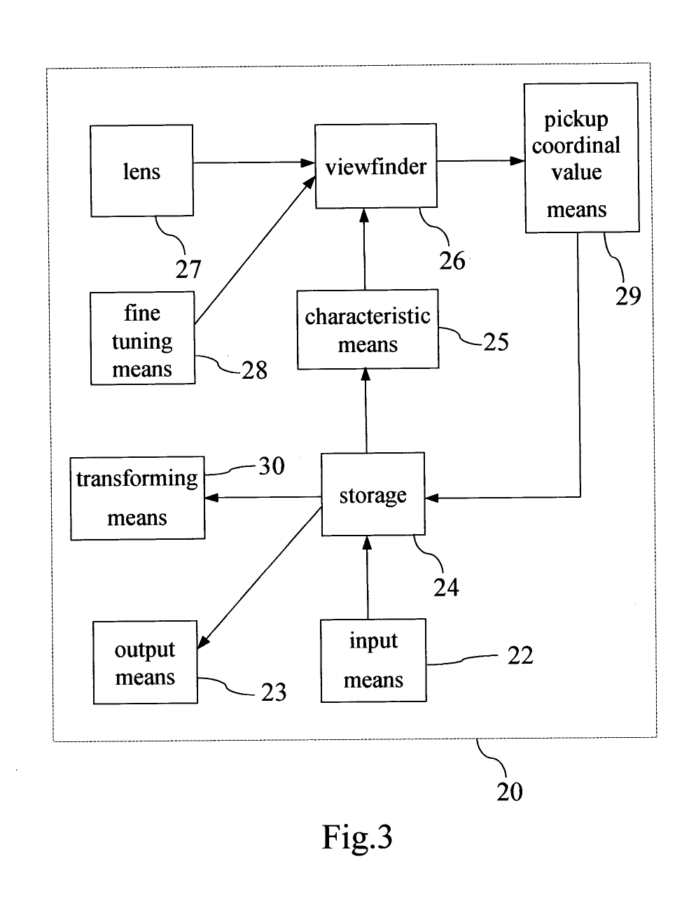

Referring to FIG. 3, which is a diagram illustrating additional functions of a method for animating an image according to an embodiment of the present invention;

The viewfinder 26 further comprises a fine tuning means 28 to adjust the characteristic mark to exactly match the characteristic selecting area of the target image. After the fine tuning means 28 adjusts the position, the apparatus 20 needs a pickup coordinal value means 29 for capturing at least one coordinal value to transform the characteristic selecting area of the target image. The animated image is generated by a transforming means 30 and storing the target image and coordinal value on storage 24. Therefore, the animated image can be displayed by an output means 23 for outputting the at least coordinal value and said target image, for example, an LCD, OLED or STN. Furthermore, the characteristic mark data can be stored in the storage 23 by an input means 22.

As described above, the present invention discloses using the characteristic mark to match the characteristic selecting area of target image. The characteristic mark can be selected from one of the characteristic marks in the database for matching the target image. According to the present invention the pickup coordinal value means 29 gets the value, and stores the coordinal value and the target image in the storage. The animated image is transformed by software and the coordinal value and the target image. Further, the coordinal value and the target image can be transferred to any portable electronic device and displayed showing an animated image or combined with voice or audio.

Animating an image typically requires using complex transforming operations and animation software and takes many steps to get the transformation coordinal value. All the steps must be performed by a professional software operator. The present invention decreases the complex steps to get a transformation coordinal value and decrease the production time for animating images. Additionally, the resultant file size is reduced significantly.

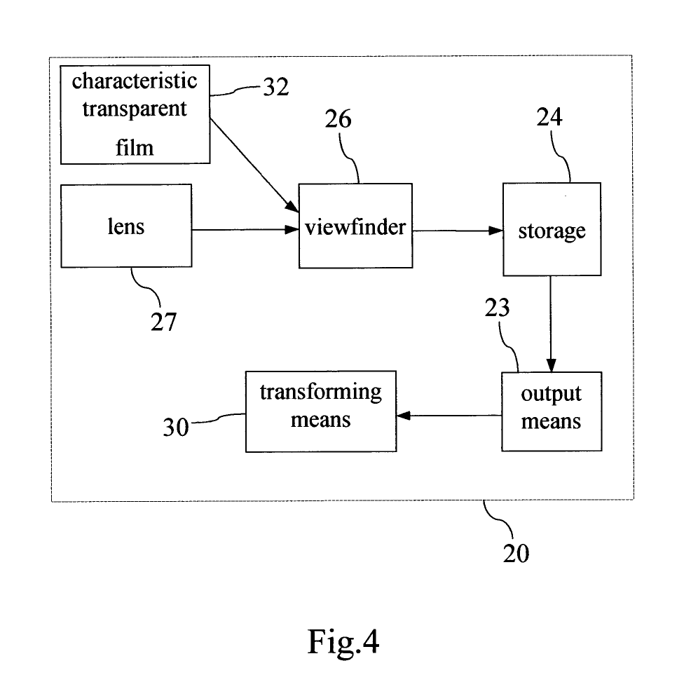

Refer to FIG. 4, which is a diagram illustrating a method for animating an image according to an embodiment of the present invention.

In another embodiment of present invention, the method provides a lens 27 for capturing the target image; a characteristic transparent film 32 having at least one characteristic mark to overlay the target image; a viewfinder 26 for checking the characteristic mark overlays the image; and a storage 24 for storing the target image and at least one coordinal value of said characteristic mark and being transformed by software. Therefore, the coordinal value and target image are transferred to any portable electron device or itself by an output means 23, and the animated image is displayed by the transforming means 30.

Therefore, the function of the characteristic transparent film 32 is the same as characteristic means 25. The conventional portable electronic device can use the characteristic transparent film and transforming software to get an animated image.

For a practical application, the following example is provided. A user with a mobile phone capable of taking still pictures looks into the viewfinder of the mobile phone camera. A mask is displayed showing proper positioning of the subject. For example, if the face of a subject is to be animated, the eyes and mouth region are displayed in the mask. The user simply adjusts the distance and position until the eye area and mouth area of the subject fit the associated regions of the mask. Once they are in proper alignment, the user can take the picture.

After the picture is taken, the areas of the image overlayed by the mask are selected using the coordinates of the mask areas. In this way, the areas of the image overlayed by the mask are transformed and result in an animated image. In this example, the eyes can blink or wink and the mouth can open and close. Additionally, a voice can be added to enhance the animated image.

Using the method of the present invention, only the image along with the location coordinates of the mask need to be stored. This results in a very small file size, making transfer and storage simple.

Continuing with the example, the user can send the image with location coordinates to a friend's mobile phone and the friend can view the animated image on their mobile phone.

Alternatively, a small transparent film can be attached over the viewfinder. The transparent film has the mask areas marked on the film. The user then continues to utilize the mask as described in the previous example by aligning and position the mask areas to the subject's face. This is an inexpensive way to use the present invention without the need for altering the software or firmware of the device to display the mask.

Furthermore, the areas to be masked can comprise other things besides facial features. For example, pets, legs, arms, cars, or other parts of objects can be used by selecting the appropriate masks.

Alternatively, instead of using a camera-equipped mobile phone, a digital camera, web camera, or other types of cameras can be used in practicing the present invention.

In another embodiment of the present invention, the animated image can be stored in a mobile phone and associated with the subject's telephone number. When the subject calls the mobile phone, the animated image is displayed. As the subject talks, the image transforms or animates synchronized to the voice.

In another embodiment of the present invention, the mask is not fixed. In this embodiment, the area of the mask can be moved to overlay areas of the image to be animated. This allows images that have been captured to be animated at a later date instead of aligning the subject and the mask at the time of capture.

It will be apparent to those skilled in the art that various modifications and variations can be made to the present invention without departing from the scope or spirit of the invention. In view of the foregoing, it is intended that the present invention cover modifications and variations of this invention provided they fall within the scope of the invention and its equivalent.

What is claimed is:

1. A method for capturing and creating an animated image comprising:
selecting a target image;
selecting at least one characteristic area of the target image for transforming;
capturing the target image and at least one coordinate value of the characteristic area overlaying the target image; and
transforming the target image that is overlayed by the characteristic area using the at least one coordinate value of the characteristic area.

2. The method for capturing and creating an animated image according to claim 1, further comprising:
moving the at least one characteristic area to overlay an area of the target image to be transformed or moving the target image to overlay the at least one characteristic area.

3. The method for capturing and creating an animated image according to claim 1, wherein the method selects different characteristic marks depending on various target images.

4. The method for capturing and creating an animated image according to claim 1, wherein the at least one characteristic area is a default position defined by a pre-set mask.

5. The method for capturing and creating an animated image according to claim 1, further comprising:
fine tuning the characteristic mark to overlay the target image.

6. The method for capturing and creating an animated image according to claim 1, whereby audio is combined with the transformed target image; and wherein the transformed target image transforms according to the audio.

7. The method for capturing and creating an animated image according to claim 1, wherein the target image is transformed by software.

8. A method for animating an image comprising:
using a mask to overlay at least one area of a target image;
capturing at least one coordinate of the target image overlayed by the mask; and
storing the target image and the at least one coordinate.

9. The method for animating an image of claim 8, wherein the mask is a transparent film mask.

10. The method for animating an image of claim 8, wherein the mask is a digital mask displayed by software.

11. The method for animating an image of claim 8, further comprising:
fine tuning the mask position to overlay the target image.

12. The method for animating an image of claim 8, whereby utilizing the target image and the at least one coordinate results in an animated image.

13. The method for animating an image of claim 8, whereby areas of the target image are animated where the mask overlays the target image.

14. The method for animating an image of claim 8, further comprising:
selecting areas of the target image overlayed by the mask;
calculating at least one coordinate of the areas of the target image overlayed by the mask; and
animating the areas of the target image overlayered by the mask using the at least one coordinate.

15. A method for animating an image comprising:
using a mask to overlay at least one area of a target image;
selecting areas of the target image overlayed by the mask;
calculating at least one coordinate of the areas of the target image overlayed by the mask;
capturing the at least one coordinate of the target image overlayed by the mask;
storing the target image and the at least one coordinate; and
animating the areas of the target image overlayed by the mask using the at least one coordinate.

16. The method for animating an image of claim 15, whereby the mask is a transparent film.

17. The method for animating an image of claim 15, wherein the mask is a digital mask displayed by software.

18. The method for animating an image of claim 15, further comprising:
fine tuning the mask position to overlay the target image.

19. The method for animating an image of claim 15, whereby utilizing the target image and the at least one coordinate results in an animated image.

20. The method for animating an image of claim 15, whereby areas of the target image are animated where the mask overlays the target image.

21. The method for animating an image of claim 15, whereby audio is combined with the animated image; and
wherein the animated image transforms according to the audio.
